(19) United States
(12) Patent Application Publication
(10) Pub. No.: US 2007/0258484 A1
(43) Pub. Date: Nov. 8, 2007

(54) NETWORK PROFILING SYSTEM HAVING PHYSICAL LAYER TEST SYSTEM

(75) Inventor: Michael Tolaio, Scotts Valley, CA (US)

Correspondence Address: ISHIMARU & ZAHRT LLP, 333 W. EL CAMINO REAL, SUITE 330, SUNNYVALE, CA, 94087, US

(73) Assignee: SUNRISE TELECOM INCORPORATED, San Jose, CA (US)

(21) Appl. No.: 11/746,030

(22) Filed: May 8, 2007

Related U.S. Application Data
(60) Provisional application No. 60/746,766, filed on May 8, 2006.

(51) Int. Cl. H04J 3/16

(52) U.S. Cl. 370/467

(57) ABSTRACT

A network profiling system is provided including providing a base station tester having both a spectrum analyzer and a vector network analyzer, inserting an optical time domain reflectometer system in the base station tester, and operating a touch screen display of the base station tester for testing a cellular base station having both a non-optical portion and a backhaul with an optical fiber. The operating of the touch screen display further includes testing the non-optical portion with the vector network analyzer, the spectrum analyzer, or a combination thereof. The operating of the touch screen display also includes testing the backhaul having the optical fiber with the optical time domain reflectometer system, and analyzing test data from the testing the non-optical portion with the backhaul.

### CROSS-REFERENCE TO RELATED APPLICATIONS

This application claims the benefit of U.S. Provisional Patent Application Ser. No. 60/746,766 filed May 8, 2006.

The present application contains subject matter related to a co-pending U.S. patent application Ser. No. 11/382,479. The related application is assigned to Sunrise Telecom Incorporated.

The present application also contains subject matter related to a concurrently filed U.S. patent application by Michael Tolaio entitled “Network Profiling System Having Nonphysical Layer Test System”. The related application is assigned to Sunrise Telecom Incorporated and is identified by docket number 21-030.

### TECHNICAL FIELD

The present invention relates generally to wireless communication and more particularly to a system for testing cellular base stations.

### BACKGROUND ART

Telecommunications equipment traditionally has been offered with a significant number of features allowing on-line system test and operational maintenance surveillance. These features allow economical system operation, administration, maintenance, and performance (OAMP) since routine system testing and monitoring must be performed on the base station and any remote antennas. A number of tests must be performed and service provider technical staff must carry and maintain numerous pieces of test equipment in order to address these tasks.

During and after initial installation of a telecommunications system, determining the integrity of a base station transmitter and cable feedline/antenna system are important concerns. The receive antenna return loss test is a diagnostic measurement routinely performed with various cellular base station products, which provides a reasonable verification of sustained antenna integrity. This test quantifies the reflection characteristics of an antenna in order to detect whether the antenna is functioning within desired parameters. The ratio of radio frequency (RF) power reflected from the antenna to the RF power applied to the antenna defines the reflection coefficient of the antenna. A reflection coefficient having a value close to zero (0) indicates that very little RF power is reflected and that the antenna is functioning properly. A reflection coefficient having a value close to one (1) indicates that most of the RF power is reflected and that the antenna is transmitting virtually zero RF power. Transmission of very low RF power indicates problems with the antenna or the cabling between the antenna transmitter, receiver, and the cellular base station, known as the backhaul.

Network analyzers measure the antenna return loss of a cellular base station antenna by injecting a swept signal covering the antenna transmit and/or receive frequencies into the device under test (DUT), i.e., antenna, and measuring the magnitude and phase of the signal that is reflected back. For example, typically, a technician connects the network analyzer to the feeder cable extending between the antenna and the base station, and injects a signal into the feeder cable. If there are any discontinuities in the feeder cable or antenna, part of the signal may be reflected back down the feeder cable to the network analyzer.

Network analyzers are primarily utilized when the antenna being tested is not currently in use. However, if a “live” (i.e., currently in-use) test is required, the injected signal has the potential to disrupt the existing radio links between the base station and customers' mobile phones. For example, when testing a receive antenna (i.e., an antenna operating at the base station receive frequencies), as the network analyzer's source sweeps through the channel that the mobile phone's transmitter occupies (i.e., up-link channel from the mobile phone to the base station), a high level of interference is experienced at the input to the base station receiver. The interference could result in a reduction of the call quality, and possibly cause the call to drop.

In analog systems, the receive antenna return loss test is performed by applying a signal from a radio test unit (RTU) in the mobile receive band and monitoring the signal of a selected receive radio that is assigned to the selected channel frequency. A directional coupler is used to allow measurement of signal energy in both the forward direction and reverse direction, and a switch matrix, that is program controlled, selects the desired direction. The power difference between the forward and reverse signal levels is a measure of the return loss or impedance match accuracy of the antenna system. The forward and reverse signals levels are measured by querying the selected receive radio for it's “receive signal strength indicator” (RSSI) output.

Many of the newer cellular base stations communicate with transmit and receive antennas by using digital transmissions through a copper or optical fiber interface. The interface connecting the mobile switching center to the cellular base station is called the backhaul. The communication across the backhaul can be one of many different protocols, such as T1/E1, T3, OC3, Ethernet, ATM, SONET, or a similar communication protocol. In order to verify the performance and general condition of the overall cellular system, the backhaul physical link and the protocols transmitted thereover must be tested, monitored, and interpreted.

Conventional backhaul test solutions are separate systems and do not cooperate with cellular test systems. Test data may be gathered and interpreted by a separate database and software often resulting in additional problems such as incomplete or inaccurate performance analysis and database incompatibilities to name a few. These problems create obstacles for delivering OAMP.

Thus, a need still remains for an efficient network profiling system that can analyze cellular base stations from antennas to the backhaul simply and quickly. In view of the increasing demand for voice and data communications, it is increasingly critical that answers be found to these problems. Another aspect driving change is the ever-increasing need to save costs and improve efficiencies, makes it more and more critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides a network profiling system is provided including providing a base station tester having both a spectrum analyzer and a vector network analyzer, inserting an optical time domain reflectometer system in the base station tester, and operating a touch screen display of the base station tester for testing a cellular base station having both a non-optical portion and a backhaul with an optical fiber. The operating of the touch screen display further includes testing the non-optical portion with the vector network analyzer, the spectrum analyzer, or a combination thereof. The operating of the touch screen display also includes testing the backhaul having the optical fiber with the optical time domain reflectometer system, and analyzing test data from the testing the non-optical portion with the backhaul.

Certain embodiments of the invention have other aspects in addition to or in place of those mentioned or are obvious from the above. The aspects will become apparent to those skilled in the art from a reading of the following detailed description when taken with reference to the accompanying drawings.

### BRIEF DESCRIPTION OF THE DRAWINGS

FIG. 1 is a diagram of a network profiling system in an embodiment of the present invention;

FIG. 2 is a functional block diagram of the base station tester, as shown in FIG. 1;

FIG. 3 is a block diagram view of the portable base station tester in a printed circuit board level; and

FIG. 4 is a flow chart of a network profiling system for the operating of the network profiling system, in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus/device are semi-diagrammatic and not to scale and, particularly, some of the dimensions are for the clarity of presentation and are shown greatly exaggerated in the drawing FIGs.

In addition, where multiple embodiments are disclosed and described having some features in common, for clarity and ease of illustration, description, and comprehension thereof, similar and like features one to another will ordinarily be described with like reference numerals. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the conventional plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

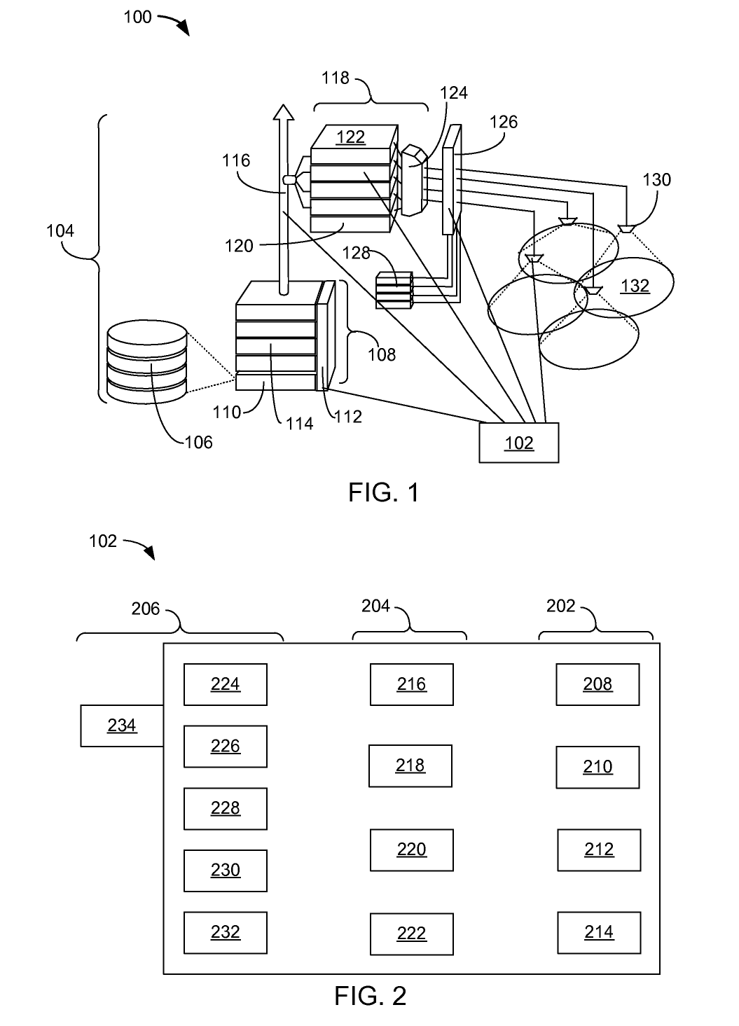

Referring now to FIG. 1, therein is shown a diagram of a network profiling system 100 in an embodiment of the present invention. The diagram depicts the network profiling system 100 having a portable base station tester 102, attached to five analysis points within a cellular base station 104. These connection points are for example only and the actual number and location of the connection to the network profiling system 100 may be in a physically different location or by linking radio frequency (RF) signals without a physical connection allowing a non-invasive sampling. The portable base station tester 102 may be transported or operated by an operator (not shown) with straps (not shown) connected to the portable base station tester 102 or the portable base station tester 102 may be a hand held test instrumentation.

The cellular base station 104 supports multiple communication functions 106, such as public safety, paging, cellular service, two way communication and telemetry, received from a mobile switching center (MSC) (not shown). The multiple communication functions 106 enter a base station head-end 108 through a radio interface unit 110, which supplies bidirectional communication for the multiple communication functions 106.

Testing of the cellular base station 104 can be performed under a variety of circumstances at the cell site, including acceptance testing during a new installation, out-of-service testing, and in-service maintenance. During acceptance testing and in-service maintenance it is highly desirable that the cellular base station 104 be operating under normal conditions.

The base station head-end 108 comprises the radio interface unit 110, a base station controller 112 and multiple instances of a base station transceiver 114. A backhaul 116, such as a T1, E1, T3, E3, ATM or optical transport, connects the base station head-end 108 to a remote hub 118. The remote hub 118 includes a packet controller 120, several of a communication encoder/decoder 122 and a bi-directional buffer 124. The remote hub 118 performs encoding of packet information for transmission to the appropriate communication service, such as paging, cellular communication, telemetry or two-way radio communication. When a return signal comes from the bi-directional buffer 124, the protocol, such as cdmaOne, CDMA2000, W-CDMA (UMTS), GSM, TDMA or AMPS, is decoded by the communication encoder/decoder 122. The bi-directional buffer 124 is connected to a Wi-Fi access control device 126.

The Wi-Fi access control device 126 controls the signal distribution to a wireless access point 128, a passive broadband antenna 130, or a combination thereof. The wireless access point would usually be used in an indoor location with limited range. The passive broadband antenna 130 is usually used in an outdoor location where wireless coverage is spread over a wide area. The passive broadband antenna 130 has a coverage area 132. By strategically placing several of the passive broadband antenna 130 large areas, up to several square miles, can be serviced by the cellular network.

The portable base station tester 102 has the ability to sample and diagnose the signals at several of the key points in the network profiling system 100. Radio frequency (RF) signals may be non-intrusively sampled at the passive broadband antenna 130 or the wireless access point 128. The RF signal is monitored for output power, frequency of the transmission, and distinct operation of the individual channels. The portable base station tester 102 has the ability to emulate a wireless handset in order to verify the receiving capabilities of both the passive broadband antenna 130 and the wireless access point 128. The portable base station tester 102 may attach directly to the Wi-Fi access control device 126 to verify the proper operation of the cellular access controls.

The portable base station tester 102 may attach directly to the remote hub 118 in order to monitor the frequency of operation and proper encoding and decoding of the packets being transferred. The internal circuitry of the portable base station tester 102 decodes the received signals and verifies that the communication encoder/decoder 122 is operating correctly. The portable base station tester 102 can identify any weakness in the remote hub 118. It is important to the operation of the network profiling system 100 that any issues are addressed prior to a complete failure of the network.

The backhaul 116 may be analyzed by the portable base station tester 102. The condition of the backhaul 116 material can be analyzed by attaching the portable base station tester 102 to the backhaul 116. The backhaul 116 may be copper coax based, optical fiber based, or a microwave link. In either case the portable base station tester 102 is capable of detecting the condition of the material, measuring the power of the communication and decoding the content. The application of the portable base station tester 102 to the backhaul 116 will be further described later.

The base station controller 112 may be connected to a mobile switching center (not shown) through the radio interface unit 110. This connection may be made through an optical fiber interface, or copper cabling. The communication path consists of one or more bi-directional, high-speed data lines that incorporate a control channel and a voice channel. The portable base station tester 102 may be used to verify the integrity of the connection to the mobile switching center (not shown). Measurements can be made of the received signals and the processing time within the base station head-end 108.

Referring now to FIG. 2, therein is shown a functional block diagram of the portable base station tester 102. The functional block diagram depicts the portable base station tester 102 having three functional groups comprising a user interface 202, a measure and control group 204 and a tester interface 206. The functional grouping preferably cooperates with one another and is not intended to limit or define the implementation of the individual circuits but is shown as an example.

The user interface 202 preferably provides a number of functions available to the operator (not shown) of the portable base station tester 102. For example, the user interface 202 includes a graphical user interface 208, a display driver 210, a push button interface 212, and a report generator 214.

The graphical user interface 208 presents tester options based on the hardware configuration available to the portable base station tester 102 and displays graphical results of tests performed. For example, the hardware configuration may include functions installed or integrated into the portable base station tester 102. Another example, the hardware configuration also may include functions available to the portable base station tester 102 but not installed or inserted.

The display driver 210 preferably works in conjunction with the graphical user interface 208. For example, the display driver 210 may configure touch screen selection of tester options. Another example, the display driver 210 may work with other human interface options, such as a mouse input (not shown).

The push button interface 212 preferably cooperates with the display driver 210 and may operate the portable base station tester 102. For example, the push button interface 212 may be used for power on/off, cursor placement, file management, volume control, tester reset, test selection, and test initiation.

The report generator 214 preferably cooperates with the push button interface 212 along with other functions of the user interface 202 and compiles information. For example, the report generator 214 compiles information indicating test selection, test parameters, test results, global position during the test, and operator notes for future reference or analysis. The report generator 214 may compile information from stored information with current test information.

The measure and control group 204 preferably provides a number of functions to the operator of the portable base station tester 102. For example, the measure and control group 204 includes a digital signal processor 216 (DSP), a protocol analysis block 218, a global positioning system 220, and a mobile handset emulator 222.

The digital signal processor 216 provides processing functions for the portable base station tester 102 and may be implemented in a number of ways. For example, the digital signal processor 216 may be implement with a single processor, a set of processors, a specialized processor or set of processors, a field programmable gate array (FPGA), or an application specific integrated circuit (ASIC) enabling the operation of the portable base station tester 102. The digital signal processor 216 may execute a number of functions for the portable base station tester 102. For example, the digital signal processor 216 may compare performance information against pre-loaded or user defined limits.

The protocol analysis block 218 preferably works in conjunction with the digital signal processor 216 to identify and interpret communication protocol and parameters. The digital signal processor 216 is preferably capable of interpreting communication protocols over RF, the backhaul 116 of FIG. 1, or a combination thereof. The RF protocols that may be interpreted include CDMA, W-CDMA (UMTS), and GSM. The communication of the backhaul 116, such as over optical fiber, includes T1/T3, E1/E3, and OC3 among others.

The global positioning system 220 preferably identifies the global position that the portable base station tester 102 was in during the execution of a test. The global positioning system 220 may be used in a number of ways. For example, the portable base station tester 102 may be used for field verification of multiple base station and antenna systems that form the network profiling system 100 of FIG. 1. The global positioning system 220 may be used to provide identification for each of the systems in the network profiling system 100. These systems are preferably monitored to aid in guaranteeing the continued operation to support service standards established with the users (not shown) of the network profiling system 100.

The mobile handset emulator 222 is preferably used to test the receive function of the wireless access point 128 of FIG. 1, and the passive broadband antenna 130 of FIG. 1. The mobile handset emulator 222 also allows the operator (not shown) to transfer voice and data information, through the network profiling system 100. For example, the operator may utilize the mobile handset emulator 222 for storing test results to a remote location (not shown) or retrieve information from a remote location for immediate analysis.

The tester interface 206 preferably provides a number of interfaces for testing the various test points in the network profiling system 100 with the portable base station tester 102. For example, the tester interface 206 includes an RF power monitor 224, a spectrum analyzer 226, a network analyzer 228, a cable analyzer 230, such as a signal generator, and an optical analyzer 232. The portable base station tester 102 may also include an interference analyzer (not shown), a channel scanner (not shown), a transmitter analyzer (not shown), and a transmission analyzer (not shown) which are accessible with the tester interface 206.

The RF power monitor 224 is preferably used with a peripheral antenna (not shown) to measure the transmitted RF signal from the wireless access point 128, and the passive broadband antenna 130. By capturing the power spectrum of the wireless access point 128 or the passive broadband antenna 130 at a known position relative to the transmitter, an indication of their performance is possible.

The RF power monitor 224 preferably works in conjunction with the digital signal processor 216 to verify the transmitter is operating within expected parameters. For example, compliance with the EIA IS-95 standard, the code division multiplex access (CDMA) may contain up to 64 channels at different power levels. The portable base station tester 102 can perform a good/bad comparison of the transmitted signal or it can collect a detailed spectrum of the RF power for later comparison. This feature allows detection of degradation in the transmission path over time.

The spectrum analyzer 226 preferably performs a frequency analysis of the transmitted signal from the wireless access point 128 and the passive broadband antenna 130. The spectrum analyzer 226 preferably captures frequency peaks and distribution present in the media being analyzed. This function can be used for RF analysis as well as the backhaul 116 and optical fiber analysis. The frequencies in the transmission and receive protocols are predetermined such that the portable base station tester 102 may preferably detect possible degradation before a complete system failure occurs.

The spectrum analyzer 226 can also be used to capture a current snapshot of the frequency performance of key components in the network profiling system 100, which may be compared against previous samples for trend analysis. A trend analysis of a series of parametric information may identify a weak component for preventing failure of the cellular base station 104 or more generally the network profiling system 100 including the backhaul 116.

The network analyzer 228 preferably works with the digital signal processor 216 and the protocol analysis block 218. The network analyzer 228 may capture and interpret the communication across the media being tested, such as the backhaul 116 or the RF energy exchanged through the wireless access point 128 or the passive broadband antenna 130. The network analyzer 228 tracks individual data threads sent across the media in order to display a performance picture of exchanges across the media being tested. If a series of errors are detected on the media being tested, further analysis of the media being tested can be performed by using one of the additional functions available in the portable base station tester 102.

The cable analyzer 230 is available to verify the integrity of the backhaul 116, in the event that the backhaul 116 is a metal media, such as copper. The cable analyzer 230 sends a data into the metal media, such as copper, of the backhaul 116 and monitors the performance, such as bit error rate.

The cable analyzer 230 may perform the verification function in a number of ways. For example, the cable analyzer 230 may use a technique know as frequency domain reflectometry to determine how far away from the source the damage is located. This operation is performed by timing the interval between the transmission of the data into the backhaul 116 and the return of the reflection from the damaged area. The standard cable measurements include return loss, one-port cable insertion loss, and fault location.

By capturing the amount of energy that is returned, an indication of the type of damage can be predicted. A small amount of reflected energy can indicate that the insulation on the metal media of the backhaul 116 has been damaged while a near total reflection of the transmitted energy would indicate that the metal media is severed somewhere along the path. The timing of the reflection is an indication of the distance from the portable base station tester 102 to the damaged area.

The portable base station tester 102 preferably provides capabilities for analyzing the backhaul 116 implemented as a fiber optic link. The optical analyzer 232 is preferably utilized to check the received optical energy for frequency dispersion or lack of intensity. Either of these conditions could indicate that the optical fiber is damaged. By linking the optical analyzer 232 with the digital signal processor 216 and the protocol analysis block 218, the backhaul 116 content can be decoded and analyzed. The coordination of the resources of the portable base station tester 102 provides a comprehensive view of the operation of the network profiling system 100 from commands arriving through the radio interface unit 110, of FIG. 1, through to RF energy transmitted through the passive broadband antenna 130, and through the backhaul 116.

The same or similar type of monitoring can be performed through the receive path. In this case, the portable base station tester 102 may operate as the mobile handset emulator 222 to send RF energy into the passive broadband antenna 130 and eventually monitor that information transferred through the radio interface unit 110 between the cellular base station 104 and the mobile switching center (not shown).

An RF antenna 234 is optionally attached to the portable base station tester 102 in order to sample transmitted frequencies. The RF antenna 234 in conjunction with the digital signal processor 216 and the RF power monitor 224 can be used to verify the parametric support for industry specifications, such as the CDMA IS-95 standard which may contain up to 64 channels at different power levels. The RF antenna 234 can be used with the network analyzer 228, the digital signal processor 216 and the protocol analysis block 218 to capture traces of the exchanges between the cellular base station 104 and mobile users (not shown).

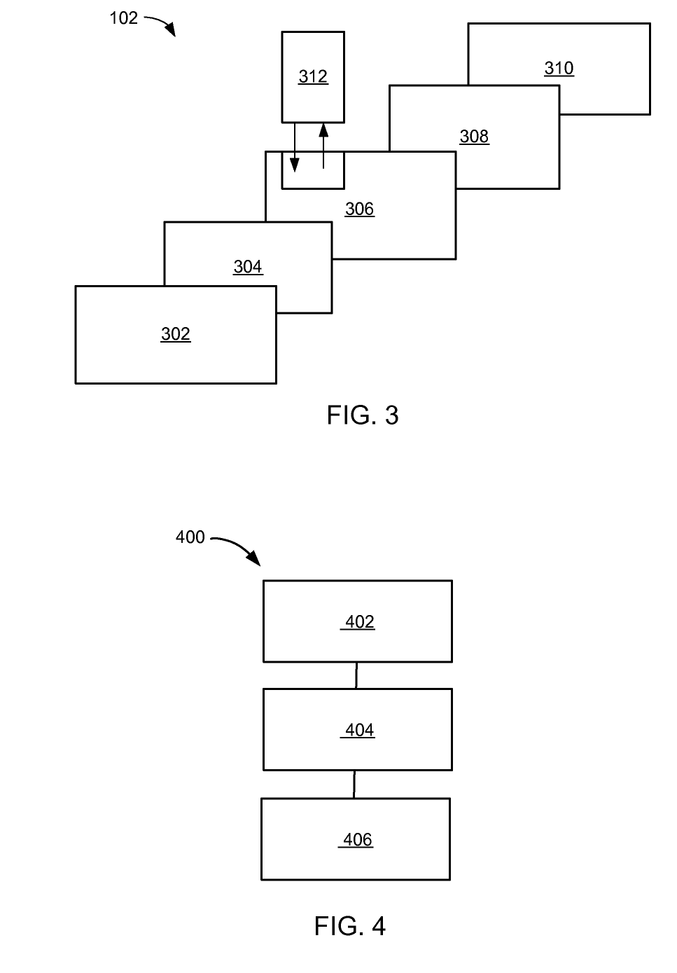

Referring now to FIG. 3, therein is shown a block diagram view of the portable base station tester 102 in a printed circuit board level. The block diagram view depicts an exemplary printed circuit board configuration of a highly integrated example of the portable base station tester 102. The portable base station tester 102 includes a touch screen display controller board 302, an operating system board 304, an interface board 306, a processing board 308, and an RF board 310.

As a more specific example of the portable base station tester 102, the RF board preferably includes both the spectrum analyzer 226 of FIG. 2 and the network analyzer 228 of FIG. 2, such as a vector network analyzer, allowing for the measurement of RF signals, either spectrum analyzer signals or vector network analyzer signals. The touch screen display controller board 302 having a touch screen display (not shown) may preferably include the user interface 202 of FIG. 2 or a portion thereof. The operating system board 304 may preferably also include the user interface 202 or a portion thereof. The interface board 306, such as a modular test toolkit board, may preferably include the tester interface 206 of FIG. 2. The processing board 308, such as a central processing unit (CPU) board, may preferably include the measure and control group 204 of FIG. 2.

For illustrative purposes, the portable base station tester 102 is shown partitioned with the touch screen display controller board 302, the operating system board 304, the interface board 306, the processing board 308, and the RF board 310. Although, it is understood that the portable base station tester 102 may be partitioned differently, such as not all the boards listed are plug-in printed circuit boards but some boards may instead be part of the main system board (not shown) having a connector (not shown) or connectors (not shown) of the portable base station tester 102 for the plug-in boards or modules.

A test system 312 may preferably be inserted into the portable base station tester 102 without having to take apart the portable base station tester 102, such as the test set. The test system 312 may be received by the interface board 306. The test system 312 integrates and cooperates with the rest of the portable base station tester 102 providing additional test capabilities. The additional test capabilities aide in providing a more comprehensive view for the network profiling system 100 of FIG. 1 resulting in improved OAMP services.

As an example, the test system 312 includes an optical time domain reflectometer (OTDR) for analyzing the backhaul 116 having optical fiber. The OTDR in the test system 312 operates with a non-RF signal or an optical signal that is accomplished by inserting the test system 312 into a pre-configured test slot of the interface board 306. Once inserted, the backhaul test mode including an optical transport analysis test, the optical time domain reflectometry detects fault locations and return loss and insertion loss within a fiber optic cable of the backhaul 116 can be made.

The test system 312, once inserted, connects to the internal circuitry (not shown) of the portable base station tester 102 located on the interface board 306. Once the test system 312 is inserted the instrument main GUI, main menu, both included in the user interface 202 is activated in the OTDR test function allowing the user to turn on the OTDR test function from the main menu and activating the OTDR measurement mode.

The test system 312 connects to the interface board 306 by an internal bus (not shown) on the test system 312 that connects to the interface board 306 and the portable base station tester 102 to the communication network. The way this works is that a user wanting to make an OTDR measurement now can select that test mode on the main instrument measurement menu. That sends a signal from the GUI of the user interface 202 to the interface board 306 to the processing board 308 by an interface (not shown), such as a universal serial bus (USB), that tells the instrument it is now time to make OTDR measurements, essentially turning off RF measurements or any other measurements at this point in time. The measurements can be made and recorded, and the main interaction of the instrument is through the processing board 308, the interface board 306, and the touch screen display controller board 302.

Testing is preferably initiated by internal firmware that activates the test system 312 enabling the test system 312 to emulate a predetermined communication test format with the test system 312, in this case, optical time domain reflectometry. A processor (not shown) of the processing board 308 coupled to the internal bus operates the test circuitry (not shown) to selectively generate the test signals in accordance with the test system 312, in this case optical time domain reflectometry. The resulting test data is displayed on the instrument's display coming back through the processor through the USB interface back through the touch screen display controller board 302.

Based on the test data, the internal firmware may activate other portions of the portable base station tester 102 to interact with the test system 312. For example, the internal firmware may active the RF board 310 to communicate with other test instruments, such as the portable base station tester 102 at another location, to validate, verify, or resolve test data. The RF board 310 and the global positioning system 220 of FIG. 2 may be cooperate with the test system 312 to resolve backscatter variability error from splice in the backhaul 116 involving different fibres with different attenuation or loss. The RF board 310 may optionally activate a remote tester, such as the portable base station tester 102, to obtain test data in the opposite direction for resolving anomalous OTDR data.

The internal firmware may also provide other validation checks improving the test and monitoring of the network profiling system 100. For example, the internal firmware may search the OTDR data for events. If events are found, the internal firmware may test for ghost events by comparing the fibre length of the backhaul 116 to the location or distance indicated by the detected event.

It has been discovered that combination of several analysis techniques within the base station tester enables rapid and comprehensive analysis of a wireless communication network issues from the RF side to the backhaul side. Capturing the parameters of the cellular communication network through the backhaul allows a unique trend analysis to be performed on the network components supporting the operation, administration, maintenance, and performance of the network profiling system.

An embodiment of the present invention enables the rapid transmission of parametric information to an alternate site for analysis or storage. The comparison of a series of measurements from the same site can be compared for variations in the power or frequency spectrums that could predict equipment failure.

The embodiment includes of a global positioning system chip within the portable base station tester allows correlation of detailed parametric information based on position of the tester relative to the passive broadband antenna.

The embodiment also includes pluggable interface allowing expansion of test capability of the portable base station tester that is integrated and works with the other functions of the portable base station tester. The expansion of the test capability allows customizable and pluggable test sets for the needs of the network to be profiled resulting in a more comprehensive testing, monitoring, and reporting of the network being profiled.

Referring now to FIG. 4, therein is shown a flow chart of a network profiling system 400 for manufacture of the network profiling system 100 in accordance with an embodiment of the present invention. The system 400 includes providing a base station tester having both a spectrum analyzer and a vector network analyzer in a block 402; inserting an optical time domain reflectometer system in the base station tester in a block 404; and operating a touch screen display of the base station tester for testing a cellular base station having both a non-optical portion and a backhaul with an optical fiber, wherein the touch screen display includes testing the non-optical portion with the vector network analyzer, the spectrum analyzer, or a combination thereof, testing the backhaul having the optical fiber with the optical time domain reflectometer system, and analyzing test data from the testing the non-optical portion with the backhaul in a block 406.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the network profiling system method and apparatus of the present invention furnish important and heretofore unknown and unavailable solutions, capabilities, and functional aspects for analyzing and maintaining cellular communication networks. The resulting processes and configurations are straightforward, cost-effective, uncomplicated, highly versatile and effective, can be implemented by adapting known technologies, and are thus readily suited for efficiently and economically manufacturing base station test devices fully compatible with conventional manufacturing processes and technologies.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hithertofore set forth herein or shown in the accompanying drawings are to be interpreted in an illustrative and non-limiting sense.

What is claimed is:

1. A network profiling system comprising:
providing a base station tester having both a spectrum analyzer and a vector network analyzer;
inserting an optical time domain reflectometer system in the base station tester; and
operating a touch screen display of the base station tester for testing a cellular base station having both a non-optical portion and a backhaul with an optical fiber includes:
testing the non-optical portion with the vector network analyzer, the spectrum analyzer, or a combination thereof,
testing the backhaul having the optical fiber with the optical time domain reflectometer system, and
analyzing test data from the testing the non-optical portion with the backhaul.

2. The system as claimed in claim 1 further comprising operating a mobile handset emulator in the base station tester for remotely activating test instrumentation at another site.

3. The system as claimed in claim 1 wherein operating the touch screen display includes selecting a report generation for display based on the test data.

4. The system as claimed in claim 1 wherein inserting the optical time domain reflectometer system includes not disassembling the base station tester.

5. The system as claimed in claim 1 wherein analyzing the test data includes operating a global positioning system in the base station tester for accessing a location of the base station tester.

6. A network profiling system comprising:
providing a base station tester having both a spectrum analyzer, a vector network analyzer, and a global positioning system;
inserting an optical time domain reflectometer system in the base station tester; and
operating a touch screen display of the base station tester for testing a cellular base station having both a non-optical portion and a backhaul with an optical fiber includes:
testing the non-optical portion with the vector network analyzer, the spectrum analyzer, or a combination thereof,
testing the backhaul having the optical fiber with the optical time domain reflectometer system,
operating the global positioning system for accessing a location of the base station tester, and
analyzing test data from the testing the non-optical portion with the backhaul including the location.

7. The system as claimed in claim 6 wherein:
inserting the optical time domain reflectometer system includes:
receiving the optical time domain reflectometer system with an interface board in the base station tester; and
testing the backhaul with the optical time domain reflectometer system further includes:
operating the optical time domain reflectometer system through an interface board in the base station tester.

8. The system as claimed in claim 6 wherein inserting the optical time domain reflectometer system in the base station tester does not increase a size of the base station tester.

9. The system as claimed in claim 6 further comprising:
operating a mobile handset emulator in the base station tester for remotely activating a test instrumentation at another site;
wherein analyzing the test data includes:
analyzing the test data with remote test data from the test instrumentation.

10. The system as claimed in claim 6 wherein analyzing the test data includes generating a report by combining the test data from the non-optical portion with the backhaul for display.

11. A network profiling system comprising:
a base station tester for attachment to a cellular base station having both a non-optical portion and a backhaul having an optical fiber includes:
a spectrum analyzer,
a vector network analyzer coupled with the spectrum analyzer, and
a touch screen display coupled to and for controlling the spectrum analyzer and the vector network analyzer; and
an optical time domain reflectometer system inserted in the base station tester and coupled with the touch screen display.

12. The system as claimed in claim 11 wherein the base station tester includes a mobile handset emulator for remotely activating test instrumentation at another site.

13. The system as claimed in claim 11 wherein the base station tester includes a report based on test data from the non-optical portion and the backhaul for display.

14. The system as claimed in claim 11 wherein the base station tester includes a processing board coupled with the spectrum analyzer, the vector network analyzer, and the optical time domain reflectometer system.

15. The system as claimed in claim 11 wherein:
the base station tester includes a global positioning system; and
the optical time domain reflectometer system is coupled with global positioning system.

16. The system as claimed in claim 11 wherein:
the base station tester includes a global positioning system coupled with the touch screen display; and
the optical time domain reflectometer system is coupled with the spectrum analyzer for testing the backhaul having the optical fiber.

17. The system as claimed in claim 16 wherein:
the base station tester includes an interface board coupled with the touch screen display; and
the optical time domain reflectometer system is in the interface board.

18. The system as claimed in claim 16 wherein the global positioning system includes a radio frequency board in the base station tester coupled with the touch screen display.

19. The system as claimed in claim 16 further comprising:
a mobile handset emulator in the base station tester for remotely activating a test instrumentation at another site; and
wherein the touch screen display is coupled with the test instrumentation by the mobile handset emulator.

20. The system as claimed in claim 16 wherein the base station tester includes a report based on a combination of test data from both the non-optical portion and the backhaul for display.
